(19) United States
(12) Patent Application Publication
(10) Pub. No.: US 2014/0278652 A1
(43) Pub. Date: Sep. 18, 2014

(54) HYBRID SYSTEM AND METHOD FOR SELECTING AND DEPLOYING FIELD TECHNICIANS IN A FACILITIES MANAGEMENT HYBRID WORKFORCE

(71) Applicant: FIRST SERVICE NETWORKS INC., Linthicum, MD (US)

(72) Inventors: Russell Joyner, Baltimore, MD (US); Clyde MOORE, Paradise Valley, AZ (US)

(73) Assignee: FIRST SERVICE NETWORKS INC., Linthicum, MD (US)

(21) Appl. No.: 13/838,494

(22) Filed: Mar. 15, 2013

(51) Int. Cl. G06Q 10/06; G06Q 10/10

(52) U.S. Cl. CPC G06Q 10/063116; G06Q 10/1053
USPC 705/7.16

(57) ABSTRACT

Methods and systems are provided for allocating tasks within a hybrid workforce which includes staff technicians and outsourced technicians in a facilities management computing environment. The method includes: identifying a geographic market where a new staff technician is needed; adding the new staff technician to a pool of staff technicians; assigning pending preventive maintenance (PM) tasks and pending service request (SR) tasks to the pool of staff technicians; calculating routes for the pool of staff technicians and dynamically establishing schedules for the pool based on the calculated routes; assigning an additional SR to the pool of staff technicians if the staff technician schedules are full; and assigning the additional SR to the outsourced technician if all of the staff technician schedules are not full.

### TECHNICAL FIELD

The present invention generally relates to computer implemented systems and methods for facilities management, and more particularly to a hybrid system and method for selecting and deploying field service technicians in a hybrid workforce.

### BACKGROUND

In the context of the present disclosure, facilities management broadly refers to the coordination of maintenance and repair activities for enterprises having multiple locations such as restaurants, shops, offices, hospitals, and virtually any other type of commercial, industrial, retail, or service site. In a typical scenario, a company specializing in third party facilities management, referred to herein as a facilities manager (FM), is contracted by the owner/operator of the business entity (the customer) to perform scheduled preventive maintenance (PM) services and non-scheduled repair services (also known as a service request or “SR”) for some or all of the customer's locations.

The contractual relationship between the FM and the customer are often embodied in a service level agreement (SLA). In order to maintain a high level of customer satisfaction, the FM is incented to quickly dispatch a technician upon receipt of a request for service, and to complete the repair in a timely and cost efficient manner.

In order to accomplish these objectives, the FM may operate one or more service centers through which the FM coordinates selecting and assigning a technician to each PM and SR activity. A particular technician, in turn, may be employed by the FM or, alternatively, the FM may contract with a local contracting company to provide service technicians and an inventory of replacement parts. In the context of the present invention, the term “hybrid” workforce refers to an FM which has its own technicians on staff, an also engages local contractors to provide technicians.

Presently known systems for managing the daily operations of an FM service center include the FUSION™ software system developed for First Service Networks, Inc. of Linthicum, Md., a leader in the field of multi-site maintenance and repair services. Information pertaining to the FUSION™ system may be found at www.firstservicenetworks.com.

The key terms governing the contractual relationship between the FM and the contractor include the technician's hourly rate and the cost for replacement parts used in connection with the maintenance and service activities. In most cases, the technician's hourly rate is agreed to in advance for the term of the contract between the FM and the contractor. Thus, the key variable subject to scrutiny often surrounds the cost of replacement parts. Presently known systems for automatically managing repair and maintenance costs are described in U.S. Pat. No. 7,685,076 B2 entitled “Online Reduction in Repair and Maintenance Costs” issued Mar. 23, 2010 and commonly assigned herewith.

Mature and robust systems have been developed for scheduling and dispatching service technicians in an on-demand environment. These systems, however, do not address the particular challenges associated with a hybrid workforce.

### SUMMARY OF THE INVENTION

In accordance with various embodiments of the present invention, systems and methods are provided for selecting, routing, and deploying technicians within a hybrid workforce in a facilities management environment.

### BRIEF DESCRIPTION OF THE DRAWING FIGURES

A more complete understanding of the subject matter may be derived by referring to the detailed description and claims when considered in conjunction with the following figures, wherein like reference numbers refer to similar elements throughout the figures, and:

FIG. 1 is a schematic block diagram of a relationship map involving a facilities management company, a contractor, a customer site, and a customer corporate headquarters in accordance with an embodiment;

FIG. 2 is a schematic block diagram of a facilities management computing environment in accordance with an embodiment;

FIG. 3 is a flow diagram of a process for optimizing a hybrid workforce in accordance with an embodiment;

FIGS. 4-8 are exemplary screenshots of an interactive user interface presented by the system for use in determining whether a particular territory needs a new staff technician in accordance with various embodiments;

FIGS. 9-11 are exemplary screenshots of an interactive user interface presented by the system for use in determining optimum job assignments to staff technicians in accordance with an embodiment; and

FIG. 12 is a flow chart illustrating an exemplary method for interactively selecting and assigning technicians to service tasks in a hybrid workforce in accordance with an embodiment.

### DETAILED DESCRIPTION OF PREFERRED EXEMPLARY EMBODIMENTS

Embodiments of the subject matter described herein generally relate to systems and methods for selecting, routing, and deploying technicians within a hybrid workforce in a facilities management environment. Specifically, the subject hybrid workforce optimization paradigm involves; i) identifying markets in need of additional staff technicians; ii) efficiently managing the schedules and routes of staff technicians; and iii) assigning tasks to outside contractors which cannot be accommodated by staff technicians.

In various embodiments, the systems and methods described herein may be implemented in computer code stored on or embodied in a computer-readable medium such as a hard drive, removable drive, or network server, and the system includes an interactive user interface displayed on a mobile computing device such as a tablet.

Turning now to FIG. 1, a relationship map 100 includes a facilities management company (also referred to as the facilities manager (FM)) 102 including a pool of staff technicians 103, a contractor including contractor technicians 104, a customer site 106, and a customer headquarters (customer HQ) 108. In a typical scenario, a customer 108, such as a restaurant, coffee shop, hospital, office, or any other type of commercial or industrial retail or service business has a plurality of associated customer sites 106 (only one such customer site 106 is shown in FIG. 1 for clarity). Due to the complex nature of facilities management involving the repair and maintenance of plumbing, electrical apparatus, heating, ventilation, and air conditioning (HVAC) systems, and the like, and further due to the geographically dispersed nature of multi-site customer organizations, many customers contract with an FM to coordinate their maintenance and repair functions under a service level agreement (SLA).

When a scheduled preventive maintenance (PM) task or a non-scheduled service request (SR) requires attention, the FM 102 dispatches a service technician to the appropriate customer site 106. In a typical scenario, the manager on duty at the customer site reports an equipment failure or other service request to the FM 102 via an alert communication indicated by broken arrow 110. The alert communication 110 may be in the form of an email, telephone call, text message, or any convenient communication modality.

In response to communication 110, the FM 102 assigns the task to a staff technician if one is available (indicated by arrow 112). If no staff technician is available, FM 102 assigns the task to contractor technician 104 (indicated by arrow 113), advising the staff technician (or contractor technician) of the nature of the problem, the location of the customer site 106, and the expected cost of the service call, expressed as an amount “not to exceed” (NTE). Upon receipt of the SR communication 112 or 113, the staff technician (arrow 115) or contractor technician (arrow 114) is dispatched to the customer site 106.

After the technician repairs the equipment or otherwise completes the work order at the customer site 106, the technician generates an electronic work ticket identifying the component parts replaced at the work site during the repair, and submits an electronic work ticket evidencing completion of the service call to the contractor HQ 104. The contractor 104 then converts the work ticket to an invoice, and submits an electronic invoice to the FM 102 for payment.

Referring now to FIG. 2, an exemplary facilities management computing environment 200 includes a server 202 that supports applications 228 for controlling the overall costs of maintaining a hybrid workforce. Specifically, applications 228 perform functions such as, inter alias i) determining whether a sufficient number of projected SR and PM tasks exist to justify hiring a new staff technician in a particular geographic territory going forward; ii) calculating routes, assigning SRs and/or PMs to staff technicians and determining their work schedules; and iii) assigning PMs and SRs to outside contractors when a staff technician is unavailable. The applications 228 are configured to access historical SR and PM data for various geographic territories, staff technician schedules, pending PMs and SRs, and outside contractor contact information from a dynamic database 230 maintained by FM service center 102.

Data, user interface screens, and templates utilized by the applications 228 may be provided via a network 245, such as a cloud computing environment, to any number of nodes or devices configured to interact with the network 245. Exemplary nodes may include: i) a tablet computer or other mobile device 240 operated by the staff and contractor technicians; ii) a computer (e.g., a desktop computer) 242 located at the contractor HQ; iii) a device 244 (e.g., a mobile or land line telephone, laptop, desktop, or tablet computer) located at the customer site 106 or otherwise used by the manager of the customer site; iv) a computer 246 located at and/or used by customer service representatives, schedulers, supervisors, and administrators associated with the FM 102; and v) a computer 248 located at or otherwise associated with the customer HQ.

The database 230 may be implemented using conventional database server hardware. In various embodiments, the database 230 shares processing hardware with the server 202 including input/output (I/O) hardware 207, a processor 205, and memory 206. In other embodiments, the database 230 may be implemented using separate physical and/or virtual database server hardware that communicates with the server 202 to perform the various functions described herein. In an exemplary embodiment, the database 230 includes a database management system or other equivalent software capable of retrieving and providing defined subsets of the data 132 128 in response to a query initiated or otherwise provided by an application 128, as described in greater detail below.

The server 202 operates with any sort of conventional processing hardware. The input/output features 207 generally represent the interface(s) to networks (e.g., to the network 245, or any other local area, wide area or other network), mass storage, display devices, data entry devices and/or the like.

The processor 205 may be implemented using any suitable operating system 209 or processing system, such as one or more processors, controllers, microprocessors, microcontrollers, processing cores and/or other computing resources spread across any number of distributed or integrated systems, including any number of “cloud-based” or other virtual systems. The memory 206 represents any non-transitory short or long term storage or other computer-readable media capable of storing programming instructions for execution on the processor 205, including any sort of random access memory (RAM), read only memory (ROM), flash memory, magnetic or optical mass storage, and/or the like. The computer-executable programming instructions, when read and executed by the server 202 and/or processor 205, cause the server 202 and/or processor 205 to create, generate, or otherwise facilitate the applications 228 and perform one or more additional tasks, operations, functions, and/or processes described herein. It should be noted that the memory 206 represents one suitable implementation of such computer-readable media, and alternatively or additionally, the server 202 could receive and cooperate with external computer-readable media that is realized as a portable or mobile component or platform, e.g., a portable hard drive, a USB flash drive, an optical disc, or the like.

With continued reference to FIG. 2, the data processing engine 260 performs bulk processing operations on the data 230 such as uploads or downloads, search queries, route calculations, schedule revisions, hybrid workforce staffing assignments, determining whether a new or additional staff technician should be hired for various service territories, and the like. In exemplary embodiments, the applications 228 may make use of interface features such as user interface screens 222.

The various computing devices that interface with the cloud 245 may employ a conventional browser application to contact the server 202, using a networking protocol such as the hypertext transport protocol (HTTP) or the like. The application 228 may contain Java, ActiveX, or other content that can be presented using conventional client software running on the client device (e.g., tablet 240); other embodiments may simply provide dynamic web or other content that can be presented and viewed by the user, as desired. As described in greater detail below, the data processing engine 260 suitably obtains the requested data from the database 230 as needed to populate the work tickets or other features of the particular application 228.

In accordance with various embodiments, applications 228 may include interactive applications for assisting administrators in determining whether to hire another staff technician in a geographic area, calculating routes, assigning PMs and SRs to staff technicians and dynamically determining their work schedules, and assigning overflow SRs and PMs to outside contractors when staff technician capacity is fully utilized. To facilitate the ensuing discussion, reference is made to the exemplary screen shots illustrated in FIGS. 4-11.

With momentary reference to FIG. 3, a flow diagram of a process 300 for managing a hybrid workforce in a facilities management computing environment is shown. More particularly, process 300 involves identifying markets in need of additional staff technicians (Task 302); efficiently managing the schedules and routes of staff technicians (Task 304); and assigning tasks to outside contractors which cannot be accommodated by staff technicians (Task 306).

Referring now to FIGS. 4-11, process 300 is implemented through an interactive user interface presented to administrators, customer service representatives (CSRs), schedulers, dispatchers, staff technicians, outside technicians, and supervisors as needed. The interactive user interface, in turn, includes a series of screenshots which prompt the user to to point and click on a touch screen, type in data, and perform various other interactive functions.

More particularly, FIGS. 4-8 depict various screenshots for assisting an administrator in evaluating whether a particular geographic region or territory has enough work flow to justify hiring a new staff technician, based on historical (and thus projected) job data. FIG. 4 is an exemplary screenshot 400 illustrating a tool for assessing future staffing needs based on historical data. Screenshot 400 includes a map 402 and associated historical job data and related overhead cost information 410 for a desired period of time such as, for example, the previous year.

Map 402 further includes a highlighted sub-region 404 defined by a target point 406 and a radius 408. Radius 408 may be determined by selecting a “circle” from a selection menu 414, and defining a desired radius in a radius field 416. Job data 410 may include any desired parameters or metrics for assisting management in evaluating whether to hire another staff technician for the territory under examination.

To further assist in the analysis, screenshot 400 allows administrators to conduct a route analysis. More particularly and referring now to FIG. 5, the route analysis reveals previous PM and SR job sites 502 within the sub-region 504 under examination, and calculates aggregate cost and profitability data 506 based on, inter alia, commercial route optimization tools such, for example, as those available at www.google.com/maps.

FIG. 6 is a screenshot 600 setting forth details of the route analysis. Specifically, the route analysis includes cost and profitability (or margin) information 602 to assist administrators and managers in determining whether to hire one or more additional staff technicians based on historical data and “best case” routing efficiencies. Moreover, by evaluating various alternate sub-regions and scenarios, an administrator can determine how to optimally allocate existing and projected staff technicians.

More particularly and referring now to FIGS. 7-8, FIG. 7 is an exemplary screenshot 700 illustrating an alternate map 702 and associated historical job data and cost information 710 for an alternate highlighted sub-region 704 defined by a different target point 706 and radius 708 for evaluating sub-region 704. As previously discussed in connection with FIGS. 4-6, radius 708 may be determined by selecting a “circle” from a selection menu 714, and defining a desired radius in a radius field 716. Job data 710 similarly includes relevant metrics for assisting management in evaluating whether to hire another staff technician for the territory under examination.

Referring now to FIG. 8, a route analysis conducted for the sub-region 804 selected in screenshot 700 reveals job sites 802 and calculates aggregate cost and profitability data 806. FIG. 8 further includes is a route analysis information block 808 to assist administrators and managers in determining whether to hire one or more additional staff technicians based on historical data and projected profitability information.

FIGS. 9-11 depict various screenshots for assisting supervisors, dispatchers, and administrators in assigning PMs and SRs to staff technicians, calculating routes, and determining (and revising) work schedules for staff technicians on an hourly, daily, and monthly basis, for example.

More particularly, FIG. 9 is an exemplary screen shot 900 including a spread sheet 902. The spreadsheet 902 sets forth the daily schedule for a plurality of staff technicians 904(a)-(g), respectively. Displaying daily, weekly, or monthly staff technician schedules facilitates dynamically assigning new SRs within the existing framework of pending SRs and PMs. In addition, it allows administrators to reform and revise technicians' schedules as individual jobs are added, deleted, and revised.

More particularly and referring now to FIG. 10, a screenshot 1000 illustrates a technique for hovering a cursor 1002 over a particular task 1004 to reveal its details in a pop-up window 1006. FIG. 11 shows a cursor 1102, after “right clicking” on a task 1104 to review a context specific menu 1106, selecting a desired menu option 1108 from the menu 1106. Selecting menu item 1108 instructs the system to reconfigure the technician's schedule going forward (i.e., “reroute from here”) after adding, deleting, or revising a particular task (task 1104 in the illustrated example). In this way, each technician's schedule may be dynamically optimized based on various parameters, including minimizing driving and travel time (also known as “windshield” time) using route optimization tools, as discussed above.

FIG. 12 is a flow chart illustrating an exemplary method 1200 for managing a hybrid workforce in a facilities management computing environment, where the hybrid workforce includes a first group of staff technicians and a second group of contracted technicians. The method 1200 involves evaluating (Task 1202) a plurality of sub-regions within a geographic territory to determine a first sub-region having enough work (e.g., sufficient projected tasks) to justify hiring a new staff technician; that is, the system determines whether the market has a need for >1 additional full time technician.

The method 1200 also includes hiring (Task 1204) the new staff technician and adding the technician to the current group of staff technicians for that sub-region. Pending service request (SR) tasks and pending preventive maintenance (PM) tasks are then allocated (Task 1206) among (assigned to) the staff technicians.

Method 1200 further involves dynamically establishing schedules (Task 1208) for each of the staff technicians based on calculated routes for the pending SRs and PMs. When a new SR needs to be assigned, the system determines whether any of the existing staff technicians have any availability capacity. If any of the staff technician schedules have availability, the system assigns (Task 1210) the new SR to the available staff technician. If, on the other hand, all of the staff technician schedules are at full capacity, method 1200 assigns (Task 1212) the additional SR to an outside (contracted) technician.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, database querying, database statistics, query plan generation, XML and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions.

For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another.

A method is thus provided for allocating tasks within a hybrid workforce of the type which includes both in house (“staff”) technicians and one or more contracted (outsourced) technicians. The method includes identifying, using a computer implemented application running on a processor, a geographic market in which a new staff technician is needed; adding the new staff technician to a pool of staff technicians in the geographic market; assigning pending preventive maintenance (PM) tasks and pending service request (SR) tasks to the pool of staff technicians; calculating routes for the pool of staff technicians; dynamically establishing schedules for each of the staff technicians in the pool based on the calculated routes; receiving an additional SR; assigning the additional SR to the pool of staff technicians if all of the staff technician schedules are not full; and assigning the additional SR to the at least one outsourced technician if all of the staff technician schedules are full.

In an embodiment, identifying a geographic market comprises comparing historical job data to a projected margin analysis for a plurality of user-defined geographic sub-regions, wherein comparing further comprises defining a plurality of sub-regions by defining a target point and a radius for each of a plurality of sub-regions.

In another embodiment, comparing further comprises calculating optimum routing data for the historical job data, and comparing cost information associated with the calculated optimum routing data to actual cost information for the historical job data. Moreover, dynamically establishing schedules comprises assigning a pending SR to a particular staff technician, and thereafter recalculating existing PMs and SRs for that staff technician based on the newly assigned SR.

In another embodiment, receiving the additional SR comprises transmitting a most recent SR from the network server to the administrator computing node, and dynamically establishing schedules comprises graphically displaying schedules for the pool of staff technicians on the administrator computing node, for example, in a daily, weekly, or monthly format.

In another embodiment, dynamically establishing schedules comprises: displaying job details for a selected scheduled task; displaying a context specific menu for the selected scheduled task including a rerouting menu option; and dynamically recalculating the schedule for the staff technician associated with the selected scheduled task upon user selection of the rerouting menu option, and wherein dynamically recalculating comprises running a route optimization routine using the processor.

The method further comprises establishing a contractual relationship with the at least one outsourced technician, wherein assigning the additional SR to the at least one outsourced technician comprises transmitting an assignment message from the network server to a contractor node associated with the at least one outsourced technician.

A method is also provided for managing a hybrid workforce in a facilities management computing environment, where the hybrid workforce includes a first group of staff technicians and a second group of contracted technicians. The method includes the steps of: evaluating a plurality of sub-regions within a geographic territory to determine a first sub-region having sufficient projected tasks to justify hiring an additional staff technician; adding the additional staff technician to the first group of staff technicians; assigning the additional staff technician to the first sub-region; allocating pending service request (SR) tasks and pending preventive maintenance (PM) tasks to the first group of staff technicians; dynamically establishing schedules for each of the first group of staff technicians based on calculated routes for the pending SRs and PMs; assigning an additional SR to the first group of staff technicians when all of the staff technician schedules are full; and assigning the additional SR to second group of contracted technicians when all of the staff technician schedules are not full.

In an embodiment, evaluating comprises comparing historical job data to a projected margin analysis for each of the plurality of sub-regions, and defining the plurality of sub-regions comprises defining a target point and a radius for each of the sub-regions.

In another embodiment, evaluating comprises calculating optimum routing data for historical job data in each sub-region, and comparing cost information associated with the calculated optimum routing data to actual cost information for the historical job data for each sub-region.

In a further embodiment, dynamically establishing schedules comprises assigning a pending SR to a particular staff technician, and thereafter recalculating existing PMs and SRs for that staff technician based on the newly assigned SR. The method also includes transmitting the additional SR from the network server to the administrator computing node.

In another embodiment, dynamically establishing schedules comprises graphically displaying schedules for the first group of staff technicians on the administrator computing node in one of a daily, weekly, and monthly format. In addition, dynamically establishing schedules comprises: displaying job details for a selected scheduled task; displaying a context specific menu for the selected scheduled task including a rerouting menu option; and dynamically recalculating the schedule for the staff technician associated with the selected scheduled task upon user selection of the rerouting menu option.

The method may also involve establishing a contractual relationship with the at least one outsourced technician, where assigning the additional SR to the at least one outsourced technician comprises transmitting an assignment message from the network server to a contractor node associated with the at least one outsourced technician.

Also provided is a computer application embodied in a non-transitory medium for operation by a one or more computer processors for performing the steps of: evaluating a plurality of sub-regions within a geographic territory to determine a first sub-region having sufficient projected tasks to justify hiring a new staff technician; adding the new staff technician to a first group of staff technicians; allocating pending service request (SR) tasks and pending preventive maintenance (PM) tasks to the first group of staff technicians; dynamically establishing schedules for each of the first group of staff technicians based on calculated routes for the pending SRs and PMs; assigning an additional SR to the first group of staff technicians when all of the staff technician schedules are full; and assigning the additional SR to a second group of contracted technicians when all of the staff technician schedules are not full.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. In a facilities management computing environment including an administrator computing node configured to interact with a network server having a processor, a method for allocating tasks within a hybrid workforce comprising staff technicians and at least one outsourced technician, the method comprising the steps of:
identifying, using a computer implemented application running on the processor, a geographic market in which a new staff technician is needed;
adding the new staff technician to a pool of staff technicians in the geographic market;
assigning pending preventive maintenance (PM) tasks and pending service request (SR) tasks to the pool of staff technicians;
calculating routes for the pool of staff technicians;
dynamically establishing schedules for each of the staff technicians in the pool based on the calculated routes;
receiving an additional SR;
assigning the additional SR to the pool of staff technicians if all of the staff technician schedules are not full; and
assigning the additional SR to the at least one outsourced technician if all of the staff technician schedules are full.

2. The method of claim 1, wherein identifying a geographic market comprises comparing historical job data to a projected margin analysis for a plurality of user-defined geographic sub-regions.

3. The method of claim 2, wherein comparing further comprises defining a plurality of sub-regions by defining a target point and a radius for each of a plurality of sub-regions.

4. The method of claim 2, wherein comparing further comprises calculating optimum routing data for the historical job data, and comparing cost information associated with the calculated optimum routing data to actual cost information for the historical job data.

5. The method of claim 1, wherein dynamically establishing schedules comprises assigning a pending SR to a particular staff technician, and thereafter recalculating existing PMs and SRs for that staff technician based on the newly assigned SR.

6. The method of claim 1, wherein receiving the additional SR comprises transmitting a most recent SR from the network server to the administrator computing node.

7. The method of claim 1, wherein dynamically establishing schedules comprises graphically displaying schedules for the pool of staff technicians on the administrator computing node.

8. The method of claim 7, wherein graphically displaying comprises displaying schedules in at least one of a daily, weekly, and monthly format.

9. The method of claim 7, wherein dynamically establishing schedules comprises:
displaying job details for a selected scheduled task;
displaying a context specific menu for the selected scheduled task including a rerouting menu option; and
dynamically recalculating the schedule for the staff technician associated with the selected scheduled task upon user selection of the rerouting menu option.

10. The method of claim 9, wherein dynamically recalculating comprises running a route optimization routine using the processor.

11. The method of claim 7, further comprising establishing a contractual relationship with the at least one outsourced technician, and wherein assigning the additional SR to the at least one outsourced technician comprises transmitting an assignment message from the network server to a contractor node associated with the at least one outsourced technician.

12. A method for managing a hybrid workforce in a facilities management computing environment, the hybrid workforce including a first group of staff technicians and a second group of contracted technicians, the method comprising the steps of:
evaluating a plurality of sub-regions within a geographic territory to determine a first sub-region having sufficient projected tasks to justify hiring an additional staff technician;
adding the additional staff technician to the first group of staff technicians;
assigning the additional staff technician to the first sub-region;
allocating pending service request (SR) tasks and pending preventive maintenance (PM) tasks to the first group of staff technicians;
dynamically establishing schedules for each of the first group of staff technicians based on calculated routes for the pending SRs and PMs;
assigning an additional SR to the first group of staff technicians when all of the staff technician schedules are full; and
assigning the additional SR to second group of contracted technicians when all of the staff technician schedules are not full.

13. The method of claim 12, wherein evaluating comprises comparing historical job data to a projected margin analysis for each of the plurality of sub-regions.

14. The method of claim 12, wherein defining the plurality of sub-regions comprises defining a target point and a radius for each of the sub-regions.

15. The method of claim 12, wherein evaluating further comprises calculating optimum routing data for historical job data in each sub-region, and comparing cost information associated with the calculated optimum routing data to actual cost information for the historical job data for each sub-region.

16. The method of claim 12, wherein dynamically establishing schedules comprises assigning a pending SR to a particular staff technician, and thereafter recalculating existing PMs and SRs for that staff technician based on the newly assigned SR.

17. The method of claim 12, further comprising transmitting the additional SR from the network server to the administrator computing node.

18. The method of claim 12 wherein:
dynamically establishing schedules comprises graphically displaying schedules for the first group of staff technicians on the administrator computing node in one of a daily, weekly, and monthly format; and
dynamically establishing schedules comprises:
displaying job details for a selected scheduled task;
displaying a context specific menu for the selected scheduled task including a rerouting menu option; and
dynamically recalculating the schedule for the staff technician associated with the selected scheduled task upon user selection of the rerouting menu option.

19. The method of claim 12, further comprising establishing a contractual relationship with the at least one outsourced technician, and wherein assigning the additional SR to the at least one outsourced technician comprises transmitting an assignment message from the network server to a contractor node associated with the at least one outsourced technician.

20. A computer application embodied in a non-transitory medium for operation by a one or more computer processors for performing the steps of:
evaluating a plurality of sub-regions within a geographic territory to determine a first sub-region having sufficient projected tasks to justify hiring a new staff technician;
adding the new staff technician to a first group of staff technicians;
allocating pending service request (SR) tasks and pending preventive maintenance (PM) tasks to the first group of staff technicians;
dynamically establishing schedules for each of the first group of staff technicians based on calculated routes for the pending SRs and PMs;
assigning an additional SR to the first group of staff technicians when all of the staff technician schedules are full; and
assigning the additional SR to a second group of contracted technicians when all of the staff technician schedules are not full.
